(19) United States
(12) Patent Application Publication
(10) Pub. No.: US 2017/0005485 A1
(43) Pub. Date: Jan. 5, 2017

(54) ELECTRONIC DEVICE, CHARGING APPARATUS, CHARGING PROGRAM, AND CHARGING METHOD

(71) Applicant: Kyocera Corporation, Kyoto (JP)

(72) Inventor: Yuuya HIROSE, Yokohama-shi (JP)

(73) Assignee: Kyocera Corporation, Kyoto (JP)

(21) Appl. No.: 15/193,161

(22) Filed: Jun. 27, 2016

(30) Foreign Application Priority Data
Jul. 2, 2015 (JP) 2015-133188

(51) Int. Cl. H02J 7/00

(52) U.S. Cl. CPC H02J 7/007; H02J 7/0052

(57) ABSTRACT

An electronic device includes: a secondary battery; a terminal, which receives electric power to charge the secondary battery; a switch, which turns on and off a connection between the secondary battery and the terminal; and a controller, which controls the switch to be turned off for a predetermined period at a time of starting to charge the secondary battery.

### CROSS-REFERENCE TO RELATED APPLICATION

This application claims priority from Japanese Patent Application No. 2015-133188 filed on Jul. 2, 2015, the entire subject matter of which is incorporated herein by reference.

### TECHNICAL FIELD

This disclosure relates to an electronic device, a charging apparatus, a charging program, and a charging method.

### BACKGROUND

In the background art, a secondary battery such as a lithium battery is used in an electronic device such as a smart phone. In such an electronic device, a technique has been known which eliminates affects of heat generation at the time of charging of the secondary battery.

### SUMMARY

According to one aspect of this disclosure, an electronic device includes: a secondary battery; a terminal, which receives electric power to charge the secondary battery; a switch, which turns on and off a connection between the secondary battery and the terminal; and a controller, which controls the switch to be turned off for a predetermined period at a time of starting to charge the secondary battery.

According to another aspect of this disclosure, a charging apparatus includes: a terminal, which is used to supply electric power to a secondary battery; a detector, which detects a current flowing to the terminal; a switch, which turns on and off a connection between the secondary battery and the terminal; and a controller, which controls the switch to be turned off if the detector detects a current for a predetermined period at a time of starting to charge the secondary battery.

According to another aspect of this disclosure, a non-transitory computer-readable medium having instructions to control electronic device to perform operations includes: detecting a start of charging of a secondary battery; and controlling a switch connected to the secondary battery to be turned off for a predetermined period at a time of starting to charge the secondary battery.

According to another aspect of this disclosure, a non-transitory computer-readable medium having instructions to control electronic device to perform operations comprising: detecting a current flowing to a terminal which is used to supply charging power to a secondary battery; and turning off a switch for a predetermined period at a time of starting to charge the secondary battery if the current is detected in the detecting.

According to another aspect of this disclosure, a charging method comprising: detecting a start of charging of a secondary battery; and controlling a switch connected to the secondary battery to be turned off for a predetermined period at a time of starting to charge the secondary battery.

According to another aspect of this disclosure, a charging method includes: detecting a current flowing to a terminal which is used to supply charging power to a secondary battery; and turning off a switch for a predetermined period at a time of starting to charge the secondary battery when the current is detected in detecting.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a schematic diagram of a charging system to which an electronic device of an embodiment of this disclosure is applied;

FIG. 2 is a block diagram of an internal configuration of a smart phone 105 illustrated in FIG. 1;

FIG. 3 is a block diagram of an internal configuration of a charger 103 illustrated in FIG. 1;

FIG. 4 is a schematic diagram illustrating a connection state of the charging system illustrated in FIG. 1;

FIG. 5 is a timing chart for operation of the charging system illustrated in FIG. 1;

FIG. 6 is a timing chart for operation of the charging system illustrated in FIG. 1;

FIG. 7 is a flowchart for operation of the charging system illustrated in FIG. 1; and

FIG. 8 is a schematic diagram illustrating a modified connection state of the charging system to which the electronic device according to an embodiment of this disclosure is applied.

### DETAILED DESCRIPTION

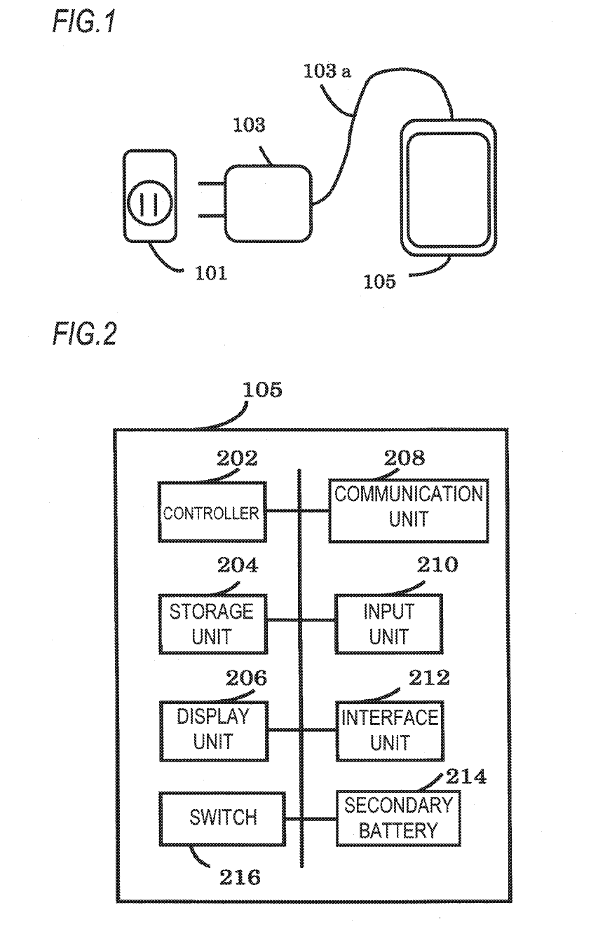

In some embodiments of electronic device will be described below with reference to the accompanying drawings. FIG. 1 is a schematic diagram of a charging system to which electronic device of this embodiment is applied. The following description also explains an embodiment of a charging program and a charging method of this disclosure.

In the electronic device, it is expected to further improve safety at the time of charging of the secondary battery.

This disclosure provides an electronic device, a charging apparatus, a charging program, and a charging method that is able to realize improvement of safety.

In FIG. 1, reference numeral 101 denotes a receptacle outlet, reference numeral 103 denotes a charger, and reference numeral 105 denotes a smart phone serving as an electronic device of an embodiment. Electric power from the receptacle outlet 101 may be supplied to the smart phone 105 through a cable 103a of the charger 103. The charger 103 and the smart phone 105 may be connected to each other by a microUSB terminal, etc.

An internal configuration of the smart phone 105 illustrated in FIG. 1 will be described below with reference to FIG. 2. FIG. 2 is a block diagram of the internal configuration of the smart phone 105 illustrated in FIG. 1.

As illustrated in FIG. 2, the smart phone 105 may include a controller (for example, CPU) 202 that controls the entire apparatus and a storage unit 204 that stores, for example, a charging program of an embodiment and other programs or data. The smart phone 105 further may include a display unit 206 that is configured by, for example, a touch panel display for displaying images, characters, or the like, and a communication unit 208 that performs communication with an external apparatus using a short-distance wireless communications or a LAN cable, for example.

The smart phone 105 further may include an input unit 210 made up of a button for ON/OFF operation of a power supply, a button for volume adjustment, and other operation buttons. The smart phone 105 further may include an interface unit 212 configured to be connected to external device such as the charger 103 by, for example, the microUSB.

The smart phone 105 further may include a secondary battery 214 that supplies electric power to the entire apparatus. The secondary battery 214 may be detachable. The secondary battery 214 is used as a power supply of the smart phone 105 in an embodiment, but may be a battery other than a lithium battery as long as storing electricity by charging and being able to be used as a battery.

The smart phone 105 further may include a switch 216 that switches to turn ON and OFF the charging power supplied from the charger 103.

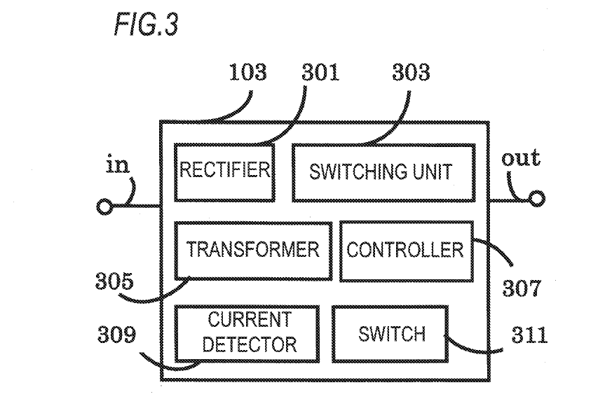

An internal configuration of the charger 103 illustrated in FIG. 1 will be described below with reference to FIG. 3. FIG. 3 is a block diagram of the internal configuration of the charger illustrated in FIG. 1.

As illustrated in FIG. 3, the charger 103 may include a rectifier 301 that may rectifie a current supplied from the receptacle outlet 101, a switching unit 303 that may convert a DC voltage into an AC voltage having a necessary duty cycle, a transformer 305 that may convert the AC voltage, and a controller 307 that may control the switching unit 303 or the like. The charger 103 may receive the electric power from an in-side terminal and outputs the electric power from an out-side terminal.

The charger 103 further may include a current detector 309 that detects a current flowing to a charging terminal for the smart phone 105 and a switch 311 that may switch on and off the current flowing to the charging terminal for the smart phone 105.

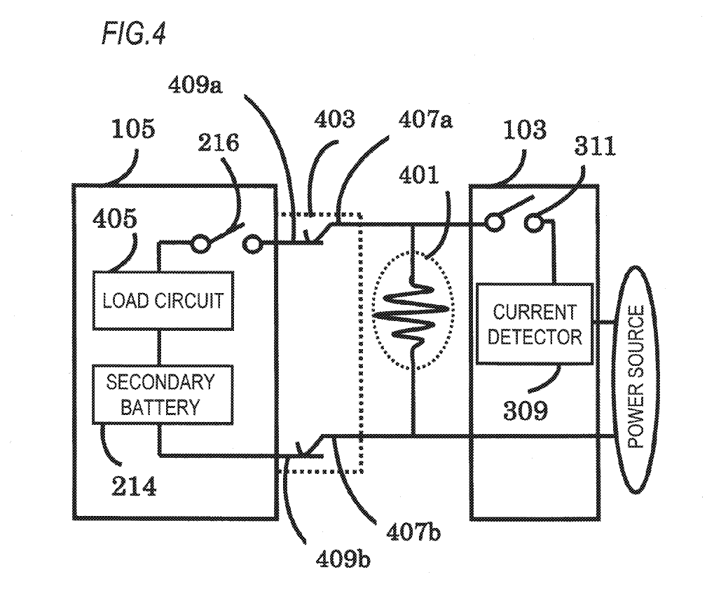

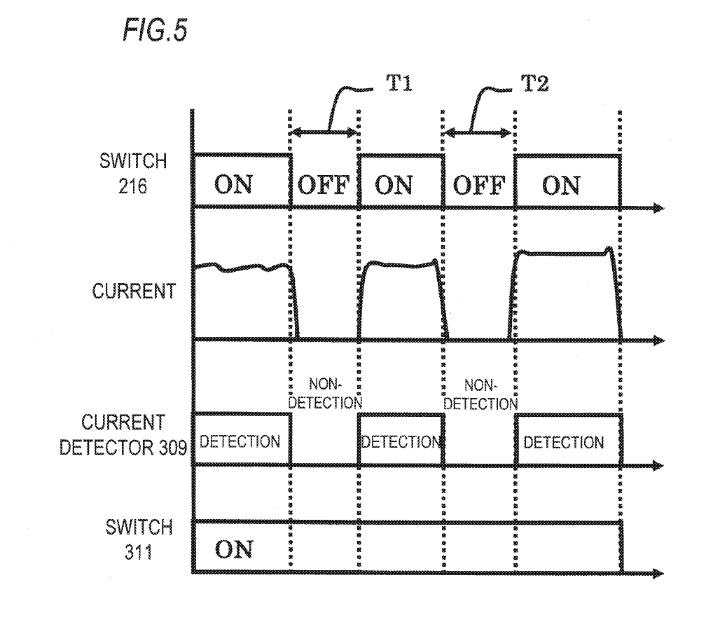

A connection state of the charging system illustrated in FIG. 1 will be described below with reference to FIG. 4. FIG. 4 is a schematic diagram illustrating a connection state of the charging system illustrated in FIG. 1. For the description of the connection relation, FIG. 4 illustrates only a part of the charging system illustrated in FIG. 1.

In FIG. 4, the charger 103 and the smart phone 105 may be connected to each other. In the charger 103, the switch 311 and the current detector 309 may be connected. Terminals 407a and 407b may be provided to be connected to the smart phone 105 and supply the electric power to the smart phone from the charger 103.

The smart phone 105 may be provided with a load circuit 405 including the display unit, the communication unit, and the like, in addition to the switch 216 and the secondary battery 214. The load circuit 405 may be connected to the switch 216 and the secondary battery 214. The smart phone 105 may include a connector 403 that may be connected to the terminals 407a and 407b of the charger 103. The smart phone 105 may include terminals 409a and 409b connected to the terminals 407a and 407b of the charger 103.

In some embodiments, it is assumed that an abnormal portion 401 has occurred between the terminals 407a and 407b of the charger 103. As the abnormal portion 401, for example, there is a short circuit between the terminals 407a and 407b or an electric leakage in the terminals 407a and 407b. Naturally, the abnormal portion 401 of an embodiment is not limited to the short circuit or the electric leakage, and may be any abnormality, for example, contamination of a foreign material such as water or dust. In some embodiments, as an example, the abnormal portion 401 due to the short circuit between the terminals 407a and 407b will be described below. It is assumed that the abnormal portion 401 has a function equivalent to resistance.

Information such as control signals may be exchanged between the charger 103 and the smart phone 105 through the terminals 407a and 407b.

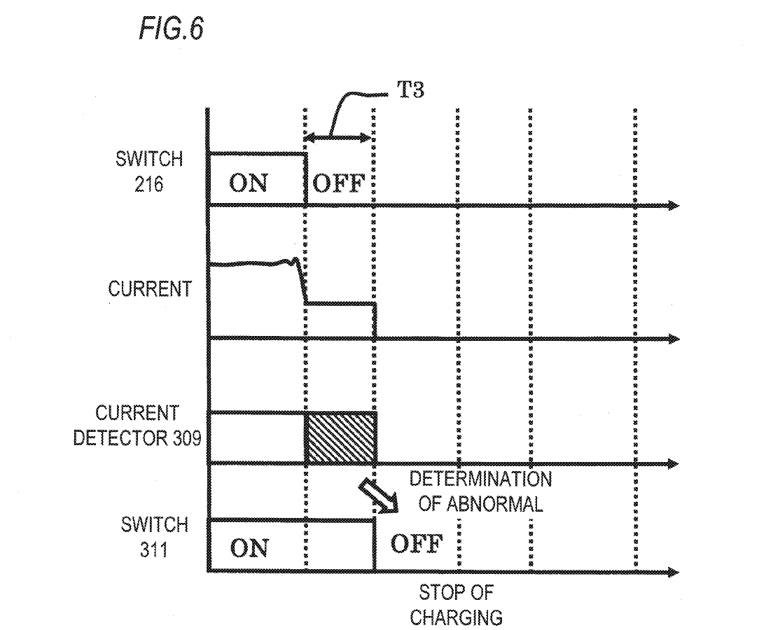

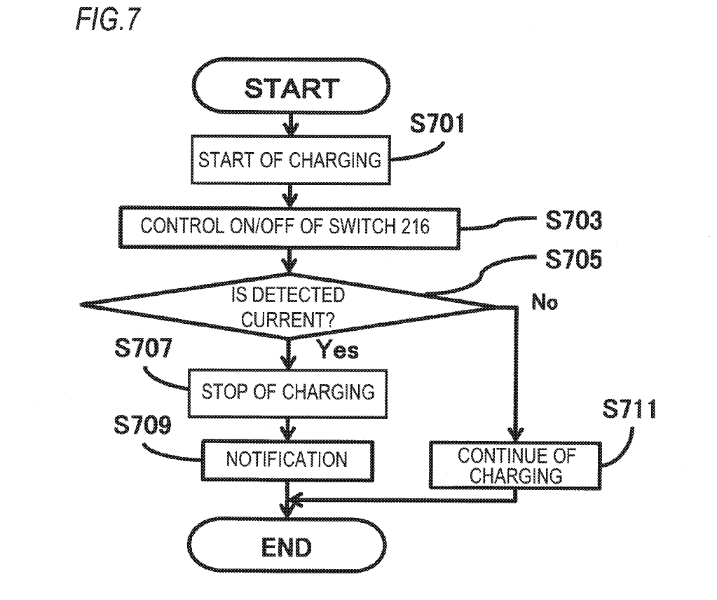

Operation of the charging system illustrated in FIG. 1 will be described below with reference to FIGS. 4, 5, 6, and 7. FIGS. 5 and 6 are timing charts for operation of the charging system illustrated in FIG. 1. FIG. 5 illustrates a timing chart in a case where abnormality does not occur in the charging system; FIG. 6 illustrates a timing chart in a case where abnormality occurs in the charging system; and FIG. 7 is a flowchart for operation of the charging system illustrated in FIG. 1.

The controller 202 of the smart phone 105 may control to start charging when the smart phone 105 and the charger 103 may be connected to each other (step S701).

The controller 202 may control ON/OFF operations of the switch 216 (step S703). The switch may be turned ON/OFF only once and may be repeatedly turned ON/OFF several times after the charger 103 is connected to the smart phone 105. In some embodiments, the controller 202 may maintain the switch 216 in the ON state in an initial state where the charger 103 is not connected to the smart phone 105. Naturally, the controller 202 may maintain the switch 216 in the OFF state in the initial state. The controller 202 may control to turn OFF the switch 216 for a short time.

Subsequently, the controller 307 of the charger 103 may determine whether to detect a current using the current detector 309 when the switch 216 is in the OFF state (step S705).

If the current is detected (“Yes” in step S705), the controller 307 may turn OFF the switch 311 and stops the charging (step S707). If the current is not detected (“No” in step S705), the controller 307 may continue to turn ON the switch 311 to continue the charging (step S711) and ends the operation.

Next, after stopping the charging, the controller 307 may notify the smart phone 105 of the fact that the current is detected (step S709) and ends the operation.

An operation of the charging system illustrated in FIG. 1 will be further described below.

1) Operation in the Normal State

When the switch 216 is turned off, the current detected by the current detector 309 becomes zero (time T1 or T2 in FIG. 5), even under the charging. The controller 307 may determine that the operation is normal by detection of the time T1 or T2 during which the current becomes zero.

2) Operation in the Abnormal State

When a current flows through a path other than an original charging path due to, for example, the presence of the abnormal portion 401, the current continuously flows between the terminal 407a and the terminal 407b even when the switch 216 is turned off. In this case, the current detector 309 may detect a current even after a certain period from the start of charging, and also may detect a current while the switch 216 is being tuned OFF (time T3 in FIG. 6). The controller 307 may determine that the abnormal occurs if the current is detected at a time period in which the current will not be detected if the operation is normal. The controller 307 may turn off the switch 311 and stops the charging (current supply) if it is determined that the abnormal occurs.

In this way, according to the charging system using the electronic device of an embodiment, the of presence or absence of abnormality occurrence is detected depending on whether the current is detected, and thus a temperature sensor or the like may be not necessary for detection of heat generation.

Therefore, according to the charging system using the electronic device of an embodiment, it may be not necessary to mount a plurality of sensor devices with assuming the heat generation in various places, and thus it is advantageous in cost as compared with a case where a sensor is mounted.

According to the charging system employing the electronic device of an embodiment, the charger 103 can detect an abnormal state. For this reason, the charger 103 can activate a protective circuit such as a current stopping switch.

This disclosure provides an electronic device, charging apparatus, a charging program, and a charging method that is able to realize improvement of safety.

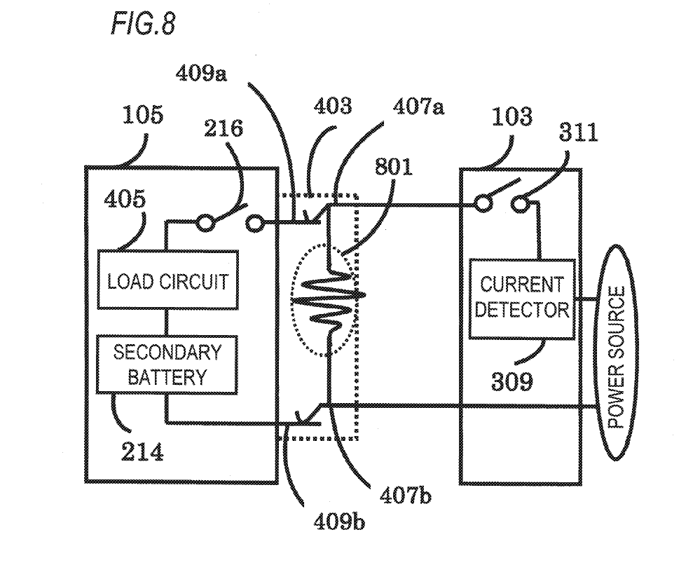

The charging system to which the electronic device according to an embodiment of this disclosure is applied is not limited to the above configuration. An example of the charging system to which the electronic device according to an embodiment of this disclosure is applied will be described with reference to FIG. 8. FIG. 8 is a schematic diagram illustrating a connection state of a modified charging system to which the electronic device according to an embodiment of this disclosure is applied.

In the charging system illustrated in FIG. 8, an abnormal portion 801 occurs inside a connector 403 of a smart phone 105. It is assumed that such an abnormal portion 801 occurs when a foreign material such as water or dust enters into the connector 403, but the abnormal portion 801 according to the modified example will not be limited thereto. The operation of the charging system illustrated in FIG. 8 is similar to that of the charging system described with reference to FIGS. 1 to 7.

The charging system illustrated in FIG. 8 also has the same effect as the charging system described with reference to FIGS. 1 to 7.

This disclosure can be variously changed without being limited to an embodiment described above. For example, the controller 307 may reduce the amount of current supply in the charging when determining to be abnormal based on the detection of the current at a time period in which the current will not be detected if the operation is normal.

Although the disclosure is based on some embodiments and the accompanying drawings, it is to be noted that various changes and modifications will be apparent to those skilled in the art based on this disclosure. Therefore, such changes and modifications may be understood as included within the scope of this disclosure. For example, in some functions and structural components and the like of some embodiments may be reordered in any logically consistent way. Furthermore, the functions and the structural components may be combined into some embodiments or divided from an embodiment.

What is claimed is:

1. An electronic device comprising:
a secondary battery;
a terminal, which receives electric power to charge the secondary battery;
a switch, which turns on and off a connection between the secondary battery and the terminal; and
a controller, which controls the first switch to be turned off for a predetermined period at a time of starting to charge the secondary battery.

2. A charging apparatus comprising:
a terminal, which is used to supply electric power to a secondary battery;
a detector, which detects a current flowing to the terminal;
a switch, which turns on and off a connection between the secondary battery and the terminal; and
a controller, which controls the switch to be turned off if the detector detects a current for a predetermined period at a time of starting to charge the secondary battery.

3. A non-transitory computer-readable medium having instructions to control electronic device to perform operations comprising:
detecting a start of charging of a secondary battery; and
controlling a switch connected to the secondary battery to be turned off for a predetermined period at a time of starting to charge the secondary battery.

4. A non-transitory computer-readable medium having instructions to control electronic device to perform operations comprising:
detecting a current flowing to a terminal which is used to supply charging power to a secondary battery; and
turning off a switch for a predetermined period at a time of starting to charge the secondary battery if the current is detected in the detecting.

5. A charging method comprising:
detecting a start of charging of a secondary battery; and
controlling a switch connected to the secondary battery to be turned off for a predetermined period at a time of starting to charge the secondary battery.

6. A charging method comprising:
detecting a current flowing to a terminal which is used to supply charging power to a secondary battery; and
turning off a switch for a predetermined period at a time of starting to charge the secondary battery when the current is detected in detecting.
